(19) United States
(12) Patent Application Publication
(10) Pub. No.: US 2026/0238500 A1
(43) Pub. Date: Aug. 13, 2026

(54) MODULAR PROTOCOL FOR MANAGING MULTIPLE DATA STREAMS IN BLOCKCHAIN SYSTEMS AND RELATED BLOCKCHAIN

(71) Applicant: Federico PODAVINI, CESENA (FC) (IT)

(72) Inventor: Federico PODAVINI, CESENA (FC) (IT)

(21) Appl. No.: 19/156,267

(22) PCT Filed: Feb. 9, 2024
(86) PCT No.: PCT/IB2024/051205

§ 371 Date: Aug. 13, 2025

(30) Foreign Application Priority Data
Feb. 14, 2023 (IT) 102023000002481

(51) Int. Cl. H04L 9/00

(52) U.S. Cl. CPC H04L 9/50

(57) ABSTRACT

A modular protocol manages streams of certified and verifiable data in blockchain systems, including smart contracts executed on blockchain nodes. The protocol defines a hierarchical structure, for managing/distributing the data stream circulating in the blockchain. A metadata collector smart contract retrieves and identifies data including a metadatum of interest. A subdivision smart contract defines a node of the protocol and receives data for regulation and distributes the data towards an address and/or another subdivision smart contract. The metadata collector smart contract directs the data towards the hierarchically highest subdivision smart contract. The metadata collector smart contract is controlled/managed by a norming user qualified to define the metadatum of interest; identify/address the highest subdivision smart contract; recognize/designate regulating users. Subdivision smart contracts are a type A smart contract, allowing only the norming user to propose modifications; a type B smart contract, allowing only a regulating user to propose modifications.

The present invention relates to a modular protocol for managing multiple data streams coming from or imported into blockchain systems. The present invention also relates to a blockchain in which the protocol according to the present invention is implemented.

It is known that a blockchain is a data structure consisting of growing lists of records, called “blocks”, securely linked together by cryptography. Each block contains a cryptographic hash of the previous block, a timestamp, and transaction data. Blockchain transactions are irreversible in that, once they have been recorded, the data in any given block cannot be modified retroactively without altering all subsequent blocks.

It is known that blockchains fall within the broader family of distributed ledgers, i.e. systems based on a register which is replicated, shared and synchronized among multiple subjects located in multiple places, but still belonging to the same entity. In a blockchain, the involved nodes are not required to know their mutual identities or trust each other because, in order to ensure consistency among the various copies, the addition of a new block is globally regulated by a shared protocol. Once the addition of a new block has been authorized, each block will update its own private copy. The very nature of the data structure guarantees that no future manipulation can occur.

Due to such characteristics, a blockchain is considered to be an alternative, in terms of security, reliability, transparency and costs, to centralized databases and ledgers managed by recognised and regulated authorities, such as, for example, administrations, banks, insurance companies, payment brokers, etc.

It is also known that a smart contract is an information technology protocol adapted to facilitate, verify and/or enforce the negotiation or execution of a contract, sometimes permitting the partial or total exclusion of a contractual clause. Smart contracts may include a user interface, and often simulate the logic of contractual clauses.

Ethereum Virtual Machines (EVMs) are known which are virtual machines belonging to the blockchain ecosystem, in particular to Ethereum's blockchains. An EVM can execute a wide range of instructions, thus being very flexible when performing many operations.

The known ERC-20 standard has introduced a standard for fungible tokens, which have a property that makes each token exactly equal, e.g. in type and value, to another token.

It is known that, in digital environments, there is an ever increasing need to be able to guarantee data stream traceability and security.

Real-life situations are known which are difficult to handle because information has to be subdivided among different users according to specific agreements. Such agreements are not mutually correlated, and it is difficult to assure the involved people that any variations will be correctly received by all the parties involved and that all changes can be traced.

The importance of this aspect is particularly felt in the field of copyright management, e.g. in the music industry.

Due to the ever increasing use of cryptocurrencies, part of copyright royalties are now paid in cryptocurrencies, so that the latter have to be appropriately distributed according to the contracts in force. Therefore, such aspects should be evaluated also in the blockchain systems in which such cryptocurrencies operate.

The need has arisen, therefore, to find a protocol for managing data streams, e.g. cryptocurrencies, wherein each distribution can be adequately traced, and wherein a high security level is guaranteed, in addition to permitting fast distributions and providing economical savings compared with traditional systems or protocols. Furthermore, such a protocol should be easily adaptable to different applications and situations, including real-world situations, and should permit the creation of structures requiring little maintenance and capable of subjecting the data stream to consistent modifications always certified and updated by guarantor users, e.g. guarantor institutions, which users shall notify all participating users in a secure manner, with the possibility of making instantaneous modifications to the data stream upon verification of specific prerequisites.

In general, the present invention aims at solving these and other technical problems by providing a protocol which permits creating modular structures and managing multiple streams of certified and verifiable data in blockchain systems, and which provides secure and fast traceability of the various data streams, thereby offering economical savings in comparison with the systems and protocols currently known in the art, while being adaptable to different requirements and contexts and also permitting the creation of easily modifiable and easy-to-maintain hierarchical structures.

The present invention permits managing such data streams while ensuring their distribution through multi-level and/or branched structures capable of adapting to any real-world need.

One aspect of the present invention relates to a protocol having the features set out in the appended claim 1.

A further aspect of the present invention relates to a blockchain having the features set out in the appended claim 12.

Auxiliary features are set out in respective dependent claims appended hereto.

The features and advantages of the protocol and blockchain will become clear and apparent in light of the following description of some possible embodiments thereof, provided herein by way of non-limiting example, as well as from the annexed drawings, wherein:

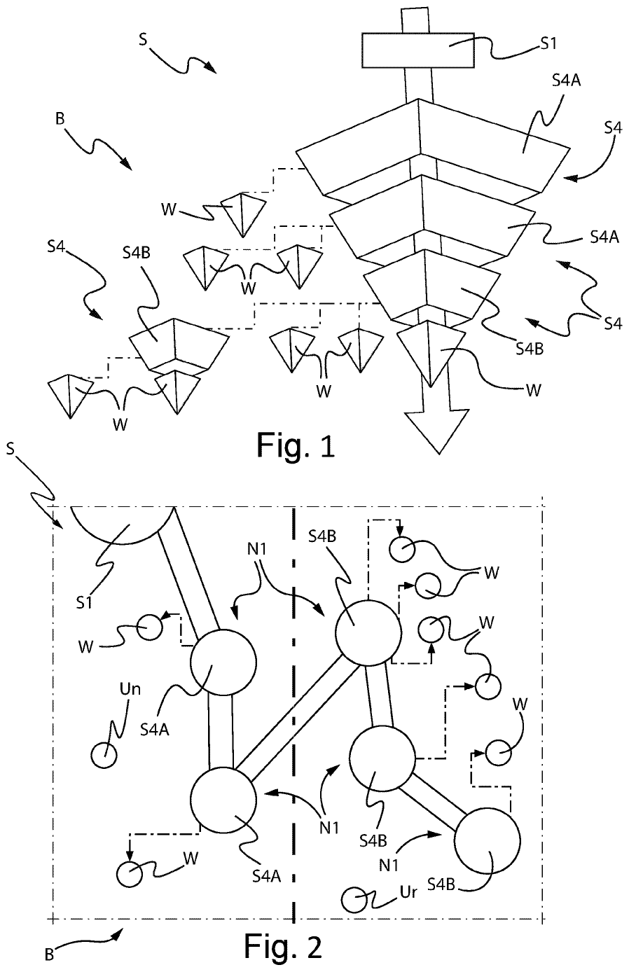

FIG. 1 shows a hierarchical structure, obtainable by means of said protocol according to the present invention, for managing a data stream through multi-level and branched structures;

FIG. 2 shows a graph structure, obtainable by means of the protocol, which comprises several smart contracts, each one connected to addresses towards which the data have to be distributed, such addresses being associated with users and/or with other smart contracts;

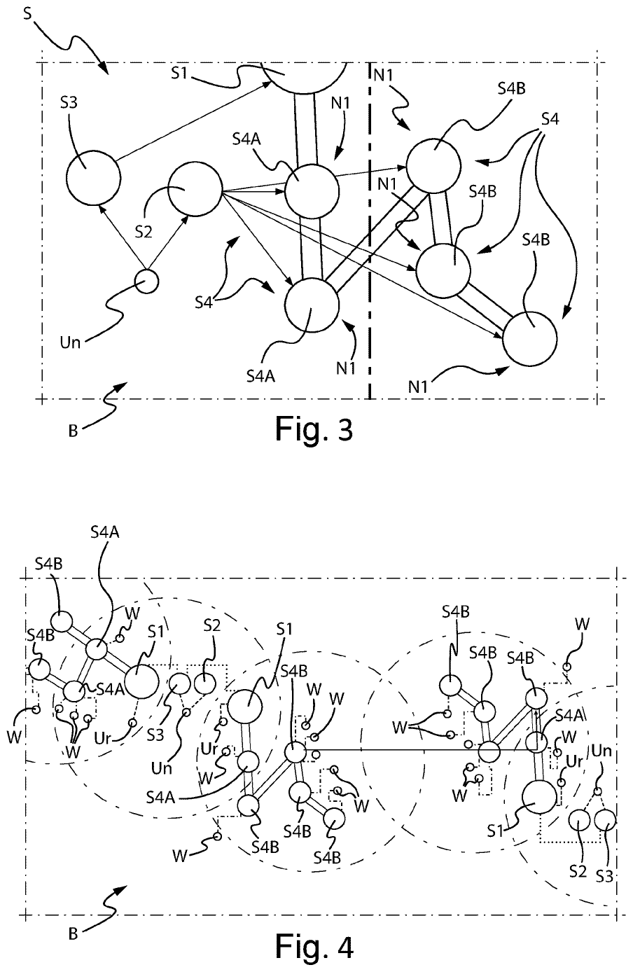

FIG. 3 shows one possible embodiment of the protocol according to the present invention, which comprises different types of smart contracts, and shows how a norming user can interact with such smart contracts in order to manage them;

FIG. 4 shows the protocol implemented in different hierarchical structures apparently independent of one another, indicating the areas or spheres of competence of the norming users and of the regulating users, and the possible interactions among the structures;

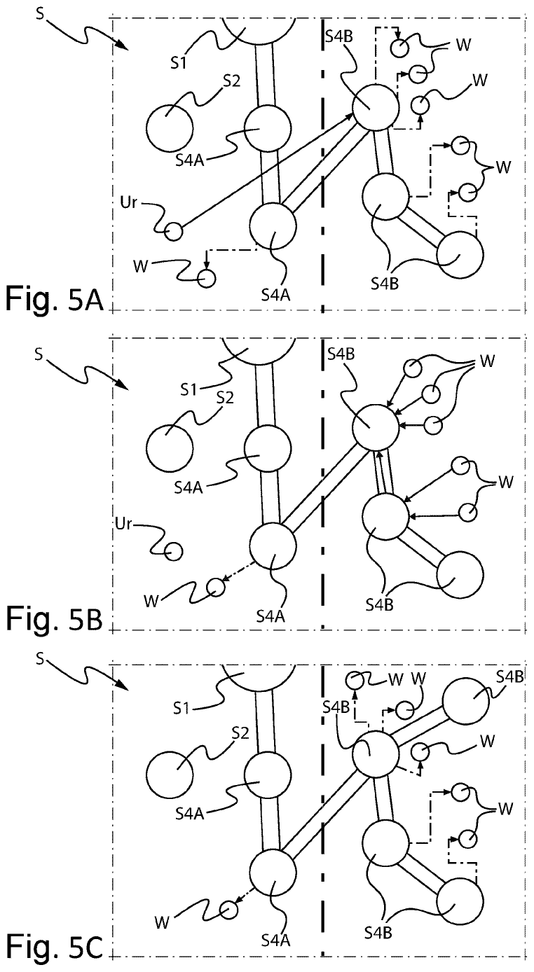

FIGS. 5A, 5B and 5C show different steps relating to a proposal for modification of a specific smart contract included in a hierarchical structure; in particular, FIG. 5A shows the proposal for modification of a type B subdivision smart contract, made by a regulating user; FIG. 5B shows the approval of such modification proposal by the users associated with the addresses concerned by such modification; FIG. 5C shows the new graph structure resulting from the acceptance of the modification proposal;

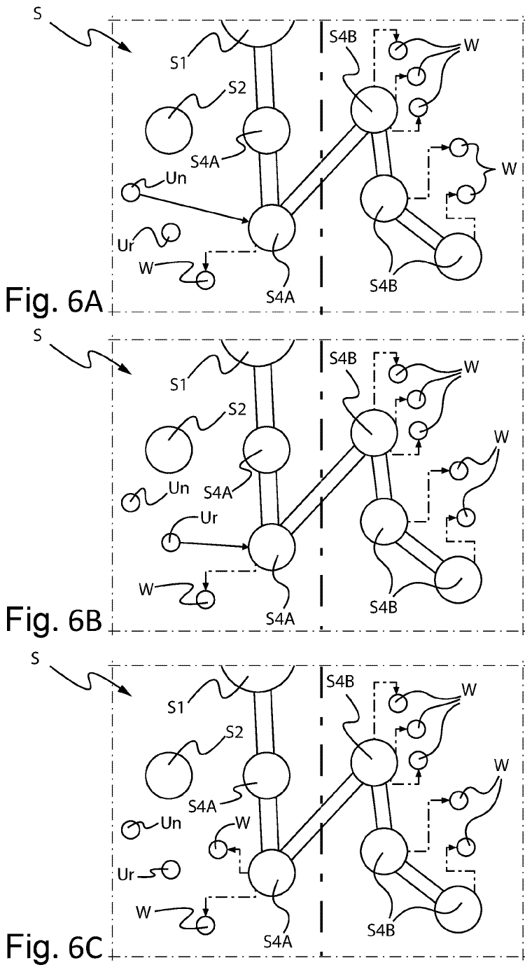

FIGS. 6A, 6B and 6C show different steps relating to a proposal for modification of a specific smart contract included in a hierarchical structure; in particular, FIG. 6A shows the proposal for modification of a type A subdivision smart contract, made by a norming user; FIG. 6B shows the approval of such modification proposal by the regulating user; FIG. 6C shows the new graph structure resulting from the acceptance of the modification proposal.

With reference to the above-listed drawings, the protocol according to the present invention is of the modular type, and is adapted to manage multiple streams of certified and verifiable data in blockchain systems.

For the purposes of the present description, the term “protocol” refers to a group of basic rules that allow data to be shared among devices or entities in a network or chain, more specifically for managing data streams in a blockchain “B”.

The protocol according to the present invention comprises a plurality of smart contracts “S”. Said smart contracts “S” are suitably saved on a blockchain “B”. Said smart contracts “S” are adapted to be executed when predetermined conditions are achieved.

Said smart contracts “S” are executed on nodes comprised in said blockchain “B”. Preferably, said smart contracts “S” comprise interfaces that allow users in a network or chain, e.g. a blockchain “B”, to modify them.

The protocol according to the present invention defines a hierarchical structure of execution of said smart contracts “S”, for the purpose of managing and distributing towards various addresses “W”, associated with users, the stream of data circulating in blockchain “B”.

The protocol according to the present invention comprises: at least one metadata collector smart contract “S1” and at least one subdivision smart contract “S4”.

Said at least one metadata collector smart contract “S1” is adapted to retrieve and identify, within said multiple data streams, those data which comprise at least one metadatum of interest. Said data comprising at least one metadatum interest have to be regulated.

Said at least one subdivision smart contract “S4” is adapted to receive the data to be regulated and distribute them towards one or more addresses “W”, associated with one or more users, and/or towards another subdivision smart contract “S4”.

Said metadata collector smart contract “S1” is adapted to direct the retrieved and identified data towards the hierarchically highest subdivision smart contract “S4” within the hierarchical structure.

Said metadata collector smart contract “S1” is controlled and managed by a norming user “Un”.

Said norming user “Un” is qualified to define the metadatum of interest to be retrieved and identified in the multiple data streams by said metadata collector smart contract “S1”.

Said norming user “Un” is qualified to identify and address, in particular to assign an address to, the hierarchically highest subdivision smart contract “S4”.

Said norming user “Un” is qualified to recognise and designate one or more regulating users “Ur” capable of contributing to the management of the hierarchical structure for the execution of said smart contracts “S”.

Each subdivision smart contract “S4” defines a node of hierarchical structure “N1”, e.g. a node of a graph structure, hereafter referred to, for simplicity, as structure node “N1”.

Each subdivision smart contract “S4” can be identified as belonging to one of the following categories: type A subdivision smart contract “S4A”; type B subdivision smart contract “S4B”.

Said type A subdivision smart contract “S4A” is so designed that norming user “Un” is the only one that can propose a modification to said type A subdivision smart contract “S4A”, and a verification by such user will always be necessary for a modification to said type A subdivision smart contract “S4A” to be approved.

Said type B subdivision smart contract “S4B” is so designed that a regulating user “Ur” is the only one that can propose a modification to said type B subdivision smart contract “S4B”, and a verification by such user will always be necessary for a modification to said type B subdivision smart contract “S4B” to be approved.

The protocol according to the present invention makes it possible to manage multiple data streams coming from or imported into blockchain systems, ensuring distribution in multi-level and/or branched structures of smart contracts “S”, defined by means of said protocol.

Said protocol can adapt itself to different applications based on real-world requirements.

The protocol guarantees traceability of the regulated data, and permits a fast and simple execution of such distributions, ensuring a high degree of security for the data and for the users associated with addresses “W”.

The protocol according to the present invention provides considerable economical savings, because it simplifies the distribution management and avoids the need for resorting to intermediaries for such activity, in addition to ensuring traceability of the data stream, e.g. a financial stream, and also of any modifications made to the hierarchical structures through which such streams flow.

The protocol according to the present invention permits the creation of hierarchical structures that can be easily managed and maintained.

The protocol according to the present invention ensures that any modifications to the data stream will always be made in a consistent and certified manner, so that all participating users can be securely notified.

The protocol according to the present invention permits instantaneous modifications to the hierarchical structure through which the data stream flows, upon verification of specific prerequisites.

The present embodiment has numerous applications and proves particularly beneficial for the definition of hierarchical structures having a simple and/or distributed structure.

The present invention ensures transparent management of the activities of regulating and distributing the data stream, which will always be up-to-date.

The protocol according to the present invention makes it possible to subdivide the management of the subdivision smart contracts “S4” among norming users “Un” and regulating users “Ur”. The present invention permits generating areas or spheres of competence of norming users “Un” and of the regulating users “Ur”, wherein each user can regulate those smart contracts which fall within the corresponding area or sphere of competence. Preferably, the areas or sphere of competence intersect each other.

By way of example, the present solution provides for having hierarchically higher smart contracts “S” managed by a norming user “Un”, who defines the basic rules, while more specific and branched rules can be delegated to regulating users “Ur” without requiring the intervention of said norming users “Un”, thus simplifying the management of the structure of smart contracts “S”. Alternatively, there is a possibility of reversing the control over the hierarchical structure, by having hierarchically higher smart contracts “S” include more specific and branched rules, which can be delegated to regulating users “Ur” without requiring the intervention of said norming users “Un”, while hierarchically lower smart contracts “S” include basic rules, managed by a norming user “Un” and applicable with reference to more specific or branched rules.

The present solution also provides a hierarchical structure having multiple levels, wherein for each level smart contracts “S” and the areas or spheres of competence are managed differently as required.

More generally, the present invention makes it possible to manage the areas or spheres of competence to adapt them to specific requirements, for the purpose of creating more complex figures, e.g. in term of intersections and dispositions, to suit real-world situations.

For the purposes of the present description, the term “modular protocol” refers to a protocol that permits the creation of basic structures of smart contracts “S” which can mutually interact as modules to create more complex structures, and the same protocol provides scalability of the structures of smart contracts “S” as needed.

More generally, said smart contracts are executed when specific conditions are met, which may be the presence of a data stream circulating in blockchain structure “B” and/or when a sufficient amount of data is reached to ensure that such data will be correctly distributed to various addresses “W”.

In some possible embodiments, said smart contracts are executed on condition that the data stream, e.g. a financial stream, comes from predetermined addresses, e.g. verified and/or authorized addresses, or upon verification that the financial stream comes from a given address. Alternatively, said smart contracts are executed upon approval by a list of addresses, the latter having been specified as being required for making any modifications to the smart contract.

In general, said smart contracts “S” are typically used for automating the execution of an agreement, so that all participating users can immediately be certain of the outcome, without involving any intermediaries or wasting time. Said smart contracts “S” may also automate a work flow, activating the next action when the required conditions are fulfilled.

More generally, the execution, particularly the activation, of a smart contract “S” determines a change of state of the blockchain itself, and in most cases triggers a data transfer, e.g. a transaction, such as a financial transaction in cryptocurrencies and/or ownership shares. The purpose of smart contracts “S” is to facilitate, verify and/or enforce the negotiation or execution of a contract.

Smart contracts “S” based on blockchain structures “B” can be partially executed or activated without human intervention.

A basic feature that characterizes smart contracts “S” is that they do not require a trusted third party, e.g. a guarantor, acting as an intermediary between the contracting parties. In fact, blockchain “B” executes the contract by itself. This reduces the friction between the parties during the data transfer, e.g. during a transaction, e.g. a financial transaction. The present invention proves to be particularly suited for the automation of transactions, e.g. financial transactions, between contracting parties.

For the purposes of the present description, the expression “hierarchical structure for the execution of said smart contracts “S”” means that smart contracts “S” included in such a structure are mutually linked in a hierarchical manner, and their connection describes a structure, e.g. a graph structure, wherein each smart contract “S” is a structure node “N1”.

Said address “W” is a functionality associated with one or more nodes of a blockchain “B” that permits transmitting and receiving a data stream, e.g. a transaction, in particular a financial transaction, within the blockchain “B”.

For the purposes of the present description, the term “user” refers to a physical or legal subject that manages one or more nodes of a blockchain and makes decisions regarding the transfer of data and the contents thereof. Preferably, an address “W” is associated with said user, through which the latter can transmit and receive a data stream within the blockchain.

In general, said metadata contain information about and/or associable with one or more addresses “W” connected to the hierarchical structure of smart contracts “S”.

In one possible embodiment of the protocol according to the present invention, the following additional smart contracts “S” are included: at least one subdivision creator smart contract “S2”; and/or at least one metadata creator smart contract “S3”.

Said at least one subdivision creator smart contract “S2” is adapted to create rules and clauses, e.g. standardized rules or clauses, for norming the data flowing in the hierarchical structure of smart contracts “S”.

Said at least one metadata creator smart contract “S3” is adapted to create rules for norming the operation of said at least one metadata collector smart contract “S1”.

Said subdivision smart contract “S4” is defined by said subdivision creator smart contract “S2”. In particular, said subdivision creator smart contract “S2” is adapted to create rules for norming the data, which rules define a subdivision smart contract “S4”.

In general, said norming user “Un” is qualified to provide information and parameters for the operation of said at least one subdivision creator smart contract “S2” and/or said at least one metadata creator smart contract “S3”.

This implementation of the protocol is particularly suitable for defining hierarchical structures with complex and/or centralized structures of smart contracts “S”.

Moreover, this embodiment £ permits, through said subdivision creator smart contract “S2” and said at least one metadata creator smart contract “S3”, the creation of complex and branched hierarchical structures of smart contracts “S”, which may include two or more metadata collector smart contracts “S1”, and a plurality of branched structures of subdivision smart contract “S4” similar to one another.

Furthermore, in the present embodiment norming user “Un” specifies and/or recognises those users that will be allowed to activate and/or approve a modification to said metadata collector smart contract “S1”; for example, norming user “Un” shall recognise and authenticate said regulating users “Ur”.

In a preferred embodiment of the protocol according to the present invention, the metadatum of interest to be retrieved and identified in the multiple data streams by metadata collector smart contract “S1” is defined exclusively by said norming user “Un”. This embodiment permits specifying which metadatum is to be searched for, and hence which data stream will have to be normed by structure of smart contracts “S” defined by means of said protocol.

Preferably, said subdivision creator smart contract “S2” is adapted to create rules and clauses, e.g. regarding information, parameters and terms, which are defined by said norming user “Un”.

In one possible, but merely illustrative and non-limiting, embodiment, said norming user “Un” is qualified to specify: addresses “W” of one or more users and/or the addresses of one or more subdivision smart contracts “S4”. Said norming user “Un” also specifies one or more data subdivision percentages. For example, said subdivision creator smart contract “S2” will, when requested by norming user “Un”, create a standard subdivision smart contract “S4” which can be recalled several times within the same hierarchical structure and which properly fulfils the requirements. For each new subdivision smart contract “S4”, said norming user “Un” supplies the address(es) “W” associated with other subdivision smart contracts “S4” towards which the data will have to be subdivided, and the corresponding subdivision percentages. Furthermore, norming user “Un” is qualified to specify and/or recognise those users that can modify a subdivision smart contract “S4”, e.g. it recognises and authenticates said regulating users “Ur”.

In one possible embodiment of the protocol according to the present invention, said subdivision creator smart contract “S2” is adapted to define a node map of the structure “N1”. Said node map is a vector adapted to associate identification codes of the structure nodes “N1”, having a domain and subdomain structure, with the addresses of the structure nodes “N1”.

In one possible embodiment of the protocol according to the present invention, said subdivision creator smart contract “S2” is adapted to create a new structure node “N1”, in particular upon request of norming user “Un”.

Said subdivision creator smart contract “S2” is adapted to define said subdivision smart contracts “S4”, which are structure nodes “N1”.

Even more preferably, said subdivision creator smart contract “S2” also performs the function of modifying a structure node “N1”, in particular upon request of norming user “Un”, in particular modifying a subdivision smart contract “S4”. Said subdivision creator smart contract “S2” can modify a subdivision smart contract “S4” based on modifications proposed by a user (Un, Ur) and, once the modification proposal has been approved, the modification will be implemented upon verification by such user (Un, Ur). For example, in case of a request for modification, coming from a norming user “Un”, of a type A subdivision smart contract “S4A”, said subdivision creator smart contract “S2” will copy the modification following the approval and upon verification by norming user “Un” and by regulating user “Ur”.

Likewise, in case of a request for modification, coming from a regulating user “Ur”, of a type B subdivision smart contract “S4B”, said subdivision creator smart contract “S2” will make the modification following the approval and upon verification by regulating user “Ur”.

In one possible embodiment of the protocol according to the present invention, said metadata creator smart contract “S3” is adapted to define a metadata map. Said metadata map is a vector adapted to associate identification codes of the metadata collector smart contract “S1” with a univocal composite identification data structure by means of a metadatum.

Furthermore, said metadata creator smart contract “S3” is adapted to create a new metadata collector smart contract “S1”. By way of example, said metadata creator smart contract “S3” will, upon request of norming user “Un”, create a standard metadata collector smart contract “S1” which can be recalled several times within the same hierarchical structure and which properly suits the requirements.

In one possible embodiment of the protocol according to the present invention, said metadata creator smart contract “S3” is adapted to modify said metadata collector smart contract “S1”. For example, in case of a request for modification, coming from a norming user “Un”, of a metadata collector smart contract “S1”, said metadata creator smart contract “S3” will make the modification to such metadata collector smart contract “S1” following the approval and upon verification by the norming user “Un”.

In one possible embodiment of the protocol according to the present invention, said type B subdivision smart contract “S4B” is adapted to create and manage substructures within the structure of smart contracts “S” created by means of the protocol according to the present invention. Said type B subdivision smart contract “S4B” can only be modified following a proposal by regulating user “Ur”.

In general, a metadata collector smart contract “S1” is designed in a manner such that multiple data streams can be identified by means of a metadatum associated with the initial stream. This variable makes it possible to exactly identify, by coding, the represented data stream, which is a unique initial data identifier. Moreover, said metadata collector smart contract “S1” is designed to store the address or address list representing the start of the data stream, in particular the address from which the data stream started.

This functionality, called whitelist, permits directing the retrieved and identified data towards the hierarchically highest subdivision smart contract “S4” only if such data stream comes from an address, i.e. a user, considered as trustworthy, so that any data streams coming from addresses, i.e. users, considered to be untrustworthy can be discarded.

Said metadata collector smart contract “S1” is designed in a manner such that thresholds can be set for data distribution. Such a threshold identifies an amount of data beyond which the metadata collector smart contract “S1” will direct the retrieved and identified data towards hierarchically highest subdivision smart contract “S4”. Said threshold can be modified, e.g. upon proposal and subsequent verification by norming user “Un” and/or by regulating user “Ur”.

Said metadata collector smart contract “S1” can also be identified by means of a variable, e.g. a Boolean variable, which represents the state of approval of the (automatic) distribution of the collected data streams. For this functionality to be activated, it must be approved by all users addressed by the structure of smart contracts “S” created by means of the protocol according to the present invention.

In addition, said metadata collector smart contract “S1” is so designed that, in the event that the conditions for activating said metadata collector smart contract “S1” are not fulfilled, a norming user “Un” will be authorized to release or withdraw the data stuck within the same metadata collector smart contract “S1” and re-address them towards an active replacement address, e.g. another metadata collector smart contract “S1” or a subdivision smart contract “S4”. This solution ensures that no data losses, e.g. financial losses, will occur in case of non-activation of the distribution of the data stream.

In general, said type A subdivision smart contract “S4A” is designed to associate a unique identifier with structure node “N1”. Said node identifier exactly identifies, by coding, the represented data stream.

Furthermore, said type A subdivision smart contract “S4A” identifies the addresses or address list, and hence the users, representing the users that must approve a modification to hierarchically higher smart contracts within the structure of smart contracts “S”.

In addition, said type A subdivision smart contract “S4A” identifies, by means of a data vector, the addresses or the address list towards which the data to be regulated must be directed, and how they must be subdivided, e.g. in percentage terms.

Said type A subdivision smart contract “S4A” can also be identified by means of a variable, e.g. a Boolean variable, which represents the state of approval of the (automatic) distribution of the received data streams. For this functionality to be activated, it must be approved by all users addressed by the same type A subdivision smart contract “S4A”, as well as by norming user “Un” and by regulating user “Ur”.

Said type a subdivision smart contract “S4A” comprises a function for modifying the addresses towards which the data to be regulated must be directed, which function can be called by norming user “Un” and/or by regulating user “Ur”. Advantageously, said function comprises a voting functionality, internal to the hierarchical structure, for approving the modification.

Said type A subdivision smart contract “S4A” comprises a node modification function, which permits changing the identifier of structure node “N1”. For this modification to be approved and verified, approval by norming user “Un” and by regulating user “Ur” is required.

Furthermore, said type A subdivision smart contract “S4A” is designed to store address or the list of addresses “W” representing the recipients of the data to be regulated. This functionality, called whitelist, permits directing the data to be regulated towards specific addresses “W”, i.e. towards specific users, only if such address “W” is considered as trustworthy, thus preventing data from being directed towards addresses “W”, i.e. users, that are considered to be untrustworthy.

In addition, said type A subdivision smart contract “S4A” is so designed that, in the event that the conditions for activating said type A subdivision smart contract “S4A” are not fulfilled, a norming user “Un” will be authorized to release or withdraw the data stuck within the same type A subdivision smart contract “S4A” and re-address them towards an active replacement address, e.g. another subdivision smart contract “S4” or an address “W”. This solution ensures that no data losses, e.g. financial losses, will occur in case of non-activation of the distribution of the data stream.

In general, said type B subdivision smart contract “S4B” is designed to associate a unique identifier with the structure node “N1”. Said node identifier exactly identifies, by coding, the represented data stream.

Furthermore, said type B subdivision smart contract “S4B” identifies the addresses or address list, and hence the users, representing the users that must approve any modifications to hierarchically higher smart contracts within the structure of smart contracts “S”.

In addition, said type B subdivision smart contract “S4B” identifies, by means of a data vector, the addresses “W” or list of addresses “W” towards which the data to be regulated must be directed, and how they must be subdivided, e.g. in percentage terms.

Said type B subdivision smart contract “S4B” can also be identified by means of a variable, e.g. a Boolean variable, which represents the state of approval of the (automatic) distribution of the received data streams. For this functionality to be activated, it must be approved by all users addressed by the same type B subdivision smart contract “S4B” and by regulating user “Ur”.

Said type B subdivision smart contract “S4B” comprises a function for modifying the addresses towards which the data to be regulated must be directed, which function can only be called by regulating user “Ur”. Advantageously, said function comprises a voting functionality, internal to the hierarchical structure, for approving the modification.

Said type B subdivision smart contract “S4B” comprises a node modification function, which permits changing the identifier of a structure node “N1”. For this modification to be approved and verified, approval by regulating user “Ur” is required.

Furthermore, said type B subdivision smart contract “S4B” is designed to store the address or address list representing the recipients of the data to be regulated. This functionality, called whitelist, permits directing the data to be regulated towards specific addresses “W”, i.e. towards specific users, only if such address “W” is considered as trustworthy, thus preventing data from being directed towards addresses “W”, i.e. users, that are considered to be untrustworthy.

In addition, said type B subdivision smart contract “S4B” is so designed that, in the event that the conditions for activating said type B subdivision smart contract “S4B” are not fulfilled, a norming user “Un” and/or a regulating user “Ur” will be authorized to release or withdraw the data stuck within the same type B subdivision smart contract “S4B” and re-address them towards an active replacement address, e.g. another subdivision smart contract “S4” or an address “W”. This solution ensures that no data losses, e.g. financial losses, will occur in case of non-activation of the distribution of the data stream.

Preferably, said area or sphere of competence of norming user “Un” identifies one or more structure nodes “N1”, comprised in the structure of smart contracts “S”, where any actions will be proposed or verified by the same norming user “Un”. Such area or sphere of competence of a norming user “Un” includes at least one metadata collector smart contract “S1”. Therefore, by specifying the metadatum of interest, a norming user “Un” will have, through said metadata collector smart contract “S1”, the possibility of identifying rule-related data and simultaneously propose such rules to all the data streams that have to be regulated by means of said structure of smart contracts.

Preferably, said area or sphere of competence of regulating user “Ur” identifies a plurality of structure nodes “N1” where any actions will be proposed or verified by the same regulating user “Ur”. Within such area or sphere of competence, said regulating user “Ur” will have the possibility of creating and managing substructures, which may refer to particular sets of addresses “W” linked by relationships or contracts, thus being able to operate on different levels in the hierarchical structure of smart contracts “S”.

In general, said metadata collector smart contract “S1” finds and identifies, in a data stream, data that need to be regulated. The addressing of the data to be regulated by the structure of smart contracts “S”, defined by means of said protocol, preferably occurs when a predefined data threshold is reached. The data will then be directed, and distributed, towards the hierarchically highest subdivision smart contract “S4”. The same subdivision smart contract “S4” will effect the distribution, in predetermined percentages, towards one or more addresses “W” and/or towards one or more subdivision smart contracts “S4”, the latter being adapted to make further subdivisions at lower levels in the hierarchical structure.

Said addresses “W” can be associated with users, which may refer to physical or legal subjects, whether private or public.

In general, the protocol according to the present invention defines a hierarchical structure in the management of a data stream with multi-level and branched structures.

By way of example, FIG. 1 shows a hierarchical structure, which can be defined by means of the protocol according to the present invention, in the management of a data stream with multi-level and branched structures.

FIG. 1 shows how a data stream, represented by a downward-pointed arrow, first flows through said metadata collector smart contract “S1”, which then directs the retrieved and identified data towards the hierarchically highest subdivision smart contract “S4”, the latter being a type A subdivision smart contract “S4A”. In addition to directing the data to be regulated towards another subdivision smart contract “S4”, hierarchically lower and consisting of, in particular, another type A subdivision smart contract “S4A”, said first type A subdivision smart contract “S4A” shows a first subdivision of data that are directed towards a first address “W” comprised in a blockchain “B”. Likewise, hierarchically lower type A subdivision smart contract “S4A”, in addition to directing the data to be regulated towards another subdivision smart contract “S4”, hierarchically lower and, in particular, consisting of a type B subdivision smart contract “S4B”, shows two subdivisions of data that are directed towards two distinct addresses “W”.

Said type B subdivision smart contract “S4B” may either direct the data towards a specific address “W”, which receives a high percentage of the regulated data, or create a branched structure wherein, while some data are directed towards other addresses “W”, some of the data are directed towards another type B subdivision smart contract “S4B”, which in turn will direct the data towards other addresses “W”.

FIG. 1 shows a branched hierarchical structure of smart contracts “S” in a blockchain environment.

FIG. 2 shows a structure of smart contracts which can be obtained by means of the protocol according to the present invention, and which can be represented as a graph structure. Said graph structure comprises several smart contracts “S”, each one connected to addresses towards which the data have to be subdivided, consisting of addresses “W” and/or other smart contracts “S”. In particular, in FIG. 2 one can see that there is a norming user “Un” qualified to manage and control said metadata collector smart contract “S1”.

FIG. 2 shows a graph structure wherein the data retrieved and identified within said multiple data streams, which comprise at least one metadatum of interest and must be regulated by means of the same hierarchical structure of smart contracts “S”, are directed towards the hierarchically highest subdivision smart contract “S4”, in particular a type A subdivision smart contract “S4A”, which then directs the data towards both an address “W” and another type A subdivision smart contract “S4A”. The latter directs the data towards both another address “W” and another subdivision smart contract “S4”, which is a type B subdivision smart contract “S4B”. Said type B subdivision smart contract “S4B” subdivides the data among three addresses “W” and another type B subdivision smart contract “S4B”. In turn, this latter type B subdivision smart contract “S4B” subdivides the data between an address “W” and another type B subdivision smart contract “S4B”, which, finally, directs the data towards an address “W”. These type B subdivision smart contracts “S4B” lie within the area or sphere of competence of a regulating user “Ur”.

Each subdivision smart contract “S4” represents a structure node “N1” of the graph structure.

FIG. 2 provides, therefore, a different graphical representation of a branched hierarchical structure obtainable by means of the protocol according to the present invention.

FIG. 3 illustrates one possible embodiment of the protocol according to the present invention, which comprises different types of smart contracts “S”, and shows how a norming user “Un” can interact with such smart contracts for managing them. In FIG. 3, norming user “Un” interacts with a subdivision creator smart contract “S2”, which in turn can interact with various subdivision smart contracts “S4”, e.g. in order to make a modification to one or more of said subdivision smart contracts “S4”.

Likewise, norming user “Un” interacts with a metadata creator smart contract “S3”, which in turn interacts with metadata collector smart contract “S1”, e.g. in order to make a modification, e.g. to the metadatum of interest.

In the embodiment described in FIG. 3, only norming user “Un” can interact with said subdivision creator smart contract “S2” and with said metadata creator smart contract “S3”. The present embodiment ensures adequate data stream management, in order to be always aware of any changes or modifications within the structure of smart contracts “S”.

FIG. 4 shows different structures of smart contracts “S” created by means of the protocol according to the present invention. The different hierarchical structures can mutually interact and are apparently independent of one another.

FIG. 4 clearly shows also the areas or spheres of competence of norming users “Un” and of regulating users “Ur”. In this figure, two hierarchical structures share a common norming user “Un”, and each one has its own regulating user “Ur”. FIG. 4 also shows that the areas or spheres of competence of said norming user “Un” and of said regulating users “Ur” partially overlap. In FIG. 4 it is also possible to see how the hierarchical structures can mutually interact, although they have different norming users “Un” and different regulating users “Ur”. Such interaction may be a subdivision specified by a subdivision smart contract “S4” of a first hierarchical structure, which connects to another subdivision smart contract “S4” belonging to another hierarchical structure of smart contracts “S”. Such interaction may be either direct or indirect, e.g. sending to a common address “W” data that have been regulated by different structures of smart contracts “S”. FIG. 4 shows how different hierarchical structures, identifiable as management structures for data normalization, can interact with each another, e.g. being bound by aspects external to the protocol according to the present invention and/or to the blockchain in which said protocol is implemented.

The sequence of FIGS. 5A, 5B and 5C shows various steps relating to a proposal for modification of a specific smart contract “S” included in a hierarchical structure; in particular, FIG. 5A shows a proposal for modification of a type B subdivision smart contract “S4B” made by a regulating user “Ur”.

FIG. 5A shows how regulating user “Ur” interacts with said type B subdivision smart contract “S4B”, which, thanks to its modification function, can modify the addresses towards which the data stream to be regulated will have to be directed.

FIG. 5B shows the approval of such modification by the users associated with the addresses involved in such modification. For example, such approval is effected by managing voting systems internal to smart contract “S”. Lastly, FIG. 5C shows the new graph structure resulting from the acceptance of the modification proposal, wherein a type B subdivision smart contract “S4B” is addressed by type B subdivision smart contract “S4B” where the modification was approved. This implies a different distribution of the data, in percentage terms, among addresses “W” and subdivision smart contracts “S4” connected downstream of such modified type B subdivision smart contract “S4B”, according to percentages defined by the modification.

The sequence of FIGS. 6A, 6B and 6C shows various steps relating to a proposal for modification of a specific smart contract “S” included in a hierarchical structure. In particular, FIG. 6A shows the proposal for modification of a type A subdivision smart contract “S4A” made by a norming user “Un”.

FIG. 6B shows the approval of such modification proposal by regulating user “Ur”.

Lastly, FIG. 6C shows the new graph structure resulting from the acceptance of the proposal, wherein a new address “W” has been added, and such type A subdivision smart contract “S4A” will provide for distributing, according to percentages defined by the modification, the data to be regulated considering the addition of a further address “W”.

In one possible practical application of the protocol according to the present invention, the protocol is adapted for managing multiple financial streams in blockchain systems “B”. In the present application, said protocol is adapted to ensure distribution over multi-level and branched structures, wherein said addresses “W”, associated with the various users, are wallets towards which said financial streams will have to be distributed.

In this application of the protocol according to the present invention, said metadatum of interest identifies one or more of the following pieces of information: music track, interpreter, artist, identifier of movable or immovable property, a service and/or a company, etc.

In the present embodiment, the protocol is applied to multi-royalty management. Said protocol is modular, and is advantageously applicable to streams deriving from financial transactions in cryptocurrencies, such as, for example, ERC-20 EVM.

The present embodiment permits managing multiple financial streams coming from or imported into one or more blockchain systems “B”, preferably EVM blockchains and compatible ones.

The present invention ensures the distribution of financial streams in multi-level and branched structures to fulfil any real-world need.

The present embodiment of the protocol makes it possible to create modular structures and is highly scalable, particularly for royalty management applications.

The present embodiment of the protocol proves particularly beneficial for managing financial streams in the music market. In fact, by exploiting blockchain technology, the protocol makes it possible to trace any financial stream and guarantee its regulation and distribution among various wallets “W”.

In this case, said norming users “Un” are public and/or private institutions normally carrying out activities related to revenue regulation, such as, for example, the Revenue Agency, the Performing Rights Society, and other controlling bodies.

Said norming users “Un” can have entire economies, e.g. in cryptocurrencies, flow through a controlled and regulated system, leaving companies, identifiable as said regulating users “Ur”, e.g. business consultants, record labels and publishers, totally free to create and manage their own internal financial streams, distributing them transparently to their collaborators and/or artists.

Thanks to the use of metadata identifying each music track, artist and/or interpreter, it is possible to recognise the information of each financial stream flowing in blockchain “B”. Moreover, the use of metadata allows for simultaneous application of update requests regulating the blockchain's activity concerning the underlying financial stream. Said financial transactions are regulated in compliance with mechanical rights, taxes, agreements and/or any present or future regulations, ensuring transparent and always up-to-date management.

By means of the protocol according to the present invention, via said metadata collector smart contract “S1” all financial transactions are collected, in particular in cryptocurrencies, and directed towards the first subdivision smart contract “S4”, which will be the one with the highest hierarchical level. For example, through said subdivision smart contract “S4” the first percentages of taxes and regulation fees are paid, according to the applicable law, to said one or more norming user “Un”. The remaining part of the financial transaction is directed towards at least one second subdivision smart contract “S4”, which manages the streams and percentages destined to other users, e.g. regulating users “Ur”, e.g. business expert, record label, etc.

The remaining part of the financial transaction is directed towards at least one third subdivision smart contract “S4”, which manages internal subdivisions, e.g. subdivisions relating to regulating user “Ur”, in particular relating to the record label's internal contractual provisions, i.e. collaborations, producer, etc.

What remains of the financial transaction after the various subdivisions is directed to artist's private wallet “W”.

The present invention makes it clear how financial transactions can be managed by areas or spheres of competence in which norming user “Un” and/or the regulating user “Ur” operate.

The present protocol according to the present invention allows for hierarchical transaction management, since transaction distribution occurs at a higher level for aspects concerning management and regulation, in particular taxes or royalties, than for aspects concerning the management of the revenue part, e.g. the part concerning the record label, the latter being in turn hierarchically more important than the management of subroyalties and subdivisions among interpreters, producers and agents. Finally, revenues arrive at artist's wallet “W”.

In the present embodiment of the protocol, a metadata collector smart contract “S1” must record an updatable metadatum, which will then be used to recognise the track and identify the financial stream. Only norming user “Un” will be permitted to update such metadatum.

Once new search standards have been regulated following the updating of the metadatum, metadata collector smart contract “S1” will be inputted one or more ERC-20 EVM or compatible tokens and will send them to the first subdivision smart contract “S4” in the hierarchical structure linked to the music track identifiable by means of said metadatum. Only norming user “Un” will be allowed to modify the data indicating the address of the first subdivision smart contract “S4”, which is the hierarchically highest one. Any modification to metadata collector smart contract “S1” and/or to the address of the first subdivision smart contract “S4” will have to be accepted by all regulating users “Ur” involved.

A metadata collector smart contract “S1” has, as a variable, the metadatum of the initial financial stream, which exactly identifies, by coding, the represented financial stream, which is a unique initial identifier.

A metadata collector smart contract “S1” has, as a variable, the distribution value that identifies the threshold beyond which metadata collector smart contract “S1” will, at the very instant when such threshold is reached, distribute the retrieved and identified cash flow, directing it towards said first subdivision smart contract “S4”.

Said metadata collector smart contract “S1” also has, as variables, the addresses or address list representing the start of the financial stream.

Said metadata collector smart contract “S1” can be identified by an activation state represented by means of a Boolean variable. Such activation state represents the state of approval for the automatic distribution of the finances collected by metadata collector smart contract “S1” towards the addresses.

Said metadata collector smart contract “S1” also performs an activation function, which permits activating or deactivating said activation state, and hence the automatic distribution of the finances collected by metadata collector smart contract “S1” towards the addresses. A modification of the activation state by means of said function requires the approval by all users associated with addresses “W” involved.

Said metadata collector smart contract “S1” allows changing said threshold, by modifying the variable of the value that needs to be reached for a distribution to occur. Such function requires the approval by norming user “Un” and by regulating user “Ur” for the variation to occur.

Said metadata collector smart contract “S1” has a function that allows modifying the variable of the metadatum of the initial stream. For it to be activated, such function requires the approval by norming user “Un” and by regulating user “Ur”.

Said metadata collector smart contract “S1” also performs forced withdrawal and whitelist functions, as previously specified.

Said subdivision creator smart contract “S2”, if present, must create, upon request of norming user “Un”, a standard subdivision smart contract “S4” generally applicable and adaptable to specific cases. Said subdivision creator smart contract “S2” is inputted the addresses of a wallet and/or of another subdivision smart contract “S4”. Said subdivision creator smart contract “S2” is also inputted all relative percentages, as well as the users that will be allowed to modify the same subdivision smart contract “S4”.

Said subdivision creator smart contract “S2” has, as a variable, a node map, which is a vector associating an identifier of structure nodes “N1”, having a domain and subdomain structure, with the addresses associated with each structure node “N1”.

Said subdivision creator smart contract “S2” comprises a function for creating a new node. Such function permits the creation of a new structure node “N1” within the hierarchical structure. This function can be called by norming user “Un”.

Lastly, said subdivision creator smart contract “S2” further comprises a node modification function, which permits modifying a structure node “N1”.

Said metadata creator smart contract “S3”, if present, must create, upon request of the norming user “Un”, a standard metadata collector smart contract “S1”. The same norming user “Un” must specify the users that will be allowed to activate such metadata creator smart contract “S3”.

Said norming user “Un” is entitled to modify said metadata creator smart contract “S3”, while said regulating user “Ur” is entitled to approve a proposed modification.

Said metadata creator smart contract “S3” has, as a variable, a metadata map, which is a vector associating identifiers of said metadata collector smart contracts “S1” with a univocal composite identification data structure by means of a metadatum.

Said metadata creator smart contract “S3” has a function that permits the creation of a new metadata collector smart contract “S1”. Such function makes it possible to create a new metadata collector smart contract “S1” within a hierarchical structure. This function can be called by norming user “Un”.

Said metadata creator smart contract “S3” comprises also a modification function, which permits modifying one or more metadata collector smart contracts “S1”.

Lastly, said metadata creator smart contract “S3” further comprises a BULK proposal function. This function allows a norming user “Un” to propose, by creating metadata with specific identifiers, e.g. containing data such as: categories; year of creation; and/or nationality, a modification to several node structures simultaneously, which structures are identified by specific information contained in the metadata.

Said type A subdivision smart contract “S4A” is inputted the financial stream in cryptocurrencies and distributes it, according to predefined percentages, to other wallets “W” and/or to other subdivision smart contracts “S4”.

For a type A subdivision smart contract “S4A” to be activated, it is necessary that all wallets “W” specified as recipients of the financial stream, and particularly every norming user “Un” and every regulating user “Ur” included in such hierarchical structure, approve the activation, and hence the addition of said type A subdivision smart contract “S4A” to the hierarchical structure of smart contracts “S”.

Any modification, e.g. to the distribution percentages indicated in type A subdivision smart contracts “S4A”, may only be proposed by those users who were designated and entrusted by norming user “Un” to make such modifications to type A subdivision smart contract “S4A”. In particular, the designated users were specified when each specific type A subdivision smart contract “S4A” was created.

Said type A subdivision smart contract “S4A” has, as a variable, the identifier of structure node “N1”, which exactly identifies, by suitable coding, the represented financial stream, which is a unique identifier of such structure node “N1”.

Said type A subdivision smart contract “S4A” will have a list of acceptance-entitled users, specifying the addresses and wallets “W” of those users who will have to express their consent in order to implement a modification to hierarchically higher structure nodes “N1”.

Said type A subdivision smart contract “S4A” will be given an indication about the output and distribution addresses, identified by a vector containing the addresses or address list representing the addresses towards which the financial stream will have to be distributed, along with the associated distribution percentages.

The state of said type A subdivision smart contract “S4A” can be identified by means of a Boolean variable representing the state of approval for the automatic distribution, towards the output addresses, of the finances that have arrived at that smart contract.

Said state of approval can be modified by means of the corresponding activation function, so as to either allow or deny the automatic distribution of the finances that have arrived at such smart contract “S” towards the output addresses. Any change of state will require the approval by all users associated with the output addresses, as well as by every norming user “Un” and every regulating user “Ur” included in such hierarchical structure.

Said type A subdivision smart contract “S4A” includes a function for modifying the output addresses, which can only be called by norming user “Un” or by regulating user “Ur”. The same function may allow managing internal voting systems, for the purpose of speeding up the approval by the involved users, and verifying the correct implementation of such modification as required.

Said type A subdivision smart contract “S4A” includes a function for modifying the identifier of structure node “N1”, which function permits modifying the variable of the identifier of the same structure node “N1”. This function also requires such modification to be approved by both norming user “Un” and regulating user “Ur”.

Preferably, said type A subdivision smart contract “S4A” includes the following functions: forced withdrawal, acceptance, whitelist, which have already been described above.

Said type B subdivision smart contract “S4B” is inputted the financial stream in cryptocurrencies and distributes it, according to predefined percentages, to other wallets and/or to other subdivision smart contracts “S4”.

The activation of said type B subdivision smart contract “S4B” requires that all wallets “W” specified as recipients must authorize such activation, and so must all norming users “Un” and regulating users “Ur” included in the hierarchical structure.

The distribution percentages indicated in type B subdivision smart contracts “S4B” can only be modified by those users who were designated and entrusted by norming user “Un”, in particular a regulating user “Ur”, to make such modifications to type B subdivision smart contract “S4B”. In particular, the designated users, e.g. said regulating users “Ur”, were specified when each specific type B subdivision smart contract “S4B” was created. Preferably, said norming user “Un” is not entitled to modify type B subdivision smart contracts “S4B”. Any modifications to type B subdivision smart contracts “S4B” shall be proposed by regulating users “Ur”, in particular by such users only.

Said type B subdivision smart contract “S4B” has, as a variable, the identifier of the structure node “N1”, which exactly identifies, by suitable coding, the represented financial stream, which is a unique identifier of such structure node “N1”.

Said type B subdivision smart contract “S4B” will have a list of acceptance-entitled users, specifying the addresses and wallets “W” of those users who will have to express their consent in order to implement a modification to hierarchically higher structure nodes “N1”.

Said type B subdivision smart contract “S4B” will be given an indication about the output and distribution addresses, identified by a vector containing the addresses or address list representing the addresses towards which the financial stream will have to be distributed, along with the associated distribution percentages.

The state of said type B subdivision smart contract “S4B” can be identified by means of a Boolean variable representing the state of approval for the automatic distribution, towards the output addresses, of the finances that have arrived at that smart contract “S”.

Said state of approval for said type B subdivision smart contract “S4B” can be modified by means of the corresponding activation function, so as to either allow or deny the automatic distribution of the finances that have arrived at such smart contract “S” towards the output addresses. Any change of state will require the approval by all users associated with the output addresses, as well as by every regulating user “Ur” included in such hierarchical structure.

Said type B subdivision smart contract “S4B” includes a function for modifying the output addresses, which can only be called by regulating user “Ur”.

The same function may permit managing internal voting systems, for the purpose of speeding up the approval by the involved users, and verifying the correct implementation of such modification as required.

Said type B subdivision smart contract “S4B” includes a function for modifying the identifier of the structure node “N1”, which function permits modifying the variable of the identifier of the same structure node “N1”. This function requires such modification to be approved by regulating user “Ur”.

Preferably, said type B subdivision smart contract “S4B” includes the following functions: forced withdrawal, acceptance, whitelist, which have already been described above.

In general, in the present implementation of the protocol according to the present invention, the area of sphere of competence of norming user “Un”, which may be, for example, the Revenue Agency and/or the Performing Rights Society, requires that any action concerning a smart contract “S” falling within such area or sphere of competence should be proposed and verified by the same norming user “Un”. In such area or sphere of competence, through the metadatum of interest included in the metadata collector smart contract “S1”, the norming user “Un” can identify the data that concern rules or norms, so that these can be proposed simultaneously to all the financial streams that need to be regulated.

In the present implementation of the protocol according to the present invention, the area or sphere of competence of regulating user “Ur”, e.g. the record label, requires that any action concerning a smart contract “S” falling within such area or sphere of competence should be proposed and verified by the same regulating user “Ur”. In such area or sphere of competence, regulating user “Ur” will have the possibility of creating and managing substructures, even branched ones, of the hierarchical structure of smart contracts “S” in accordance with the protocol of the present invention. Such substructures definable by regulating user “Ur” may be either internal, e.g. within the record label, or external, and may be complex substructures, e.g. for featured artists, or branched substructures, e.g. for handling management and co-management services.

The protocol according to the present invention makes it possible to manage the financial stream in an innovative way, in that such stream starts from the collection of the various incomes generated, in particular cryptocurrencies, thanks to said metadata collector smart contract “S1”. When the set threshold is reached, the financial stream will be distributed towards the hierarchically highest subdivision smart contract “S4”, which will send the finances to the various addresses, which may be either wallets “W” or other subdivision smart contracts “S4”, the latter allowing for further subdivisions at lower levels, according to predefined percentages. Normally, during this first distribution, wallets “W” are associated with users consisting of institutional entities, e.g. the Revenue Agency and/or the Performing Rights Society.

The next subdivision smart contracts “S4” will distribute the finances towards various addresses, which may be either wallets “W” or other subdivision smart contracts “S4”, the latter allowing for further subdivisions at lower levels, according to predefined percentages. Said wallets “W” are associated with institutions, bodies, companies or physical persons, such as artists, managers, agents, etc.

Preferably, only norming users “Un” will have the possibility of interacting with said subdivision creator smart contracts “S2” and metadata creator smart contracts “S3”, in order to ensure an adequate management of the financial streams and to be always aware of any changes or modifications made within the hierarchical structure for the management of the financial stream, so that the latter can be regulated to know the identities of all users associated with wallets “W” addressed by the structure of smart contracts “S”.

In general, the protocol is particularly suitable for execution in a blockchain “B” comprising a plurality of nodes through which data streams flow, e.g. financial streams in one or more cryptocurrencies. Blockchains are, therefore, adapted to comprise a protocol according to the present invention, implementing it in their nodes.

Said blockchain “B”, not illustrated in detail herein, advantageously comprises a number of programmable virtual machines, e.g. EVMs. Such virtual machines can be programmed using a programming language, which may be a high-level language. By means of said programming language it is possible to create, through said virtual machines, smart contracts “S”.

Due to its decentralized functionality, complemented with the capability of storing and executing said smart contracts in the nodes of the blockchain network, e.g. through an EVM, said blockchain becomes a big decentralized computer which, by executing instructions, can carry out any specific task. Therefore, the protocol according to the present invention can be applied to any context in which it is necessary to regulate a subdivision of one entity among different users, for any purpose.

The protocol according to the present invention is fully traceable as to the executed distributions, and ensures that such distributions will occur among users in a fast and secure manner, resulting in evident economical savings, since it will not be necessary to resort to any intermediary to carry out particular distribution actions.

The protocol according to the present invention is adaptable, and hence applicable, to any requirement and context, in addition to permitting the creation of hierarchical structures that can be easily maintained, e.g. corrected, modified and/or updated.

In particular, the protocol turns out to be particularly advantageous when applied for the financial management of cryptocurrencies within private management structures, developed in blockchain environments like, for example, EVM or compatible ones. In such a context, the protocol according to the present invention permits the creation of a royalty management structure which is modular and highly scalable as required, and capable of handling financial streams, e.g. in the music market.

The applicability of the protocol in blockchain environments or systems makes it possible to trace every financial stream and guarantee the regulation and distribution thereof.

The protocol according to the present invention also proves easily adaptable to different requirements, offering regulating users “Ur” the possibility of creating and managing their own internal financial streams, distributing them transparently to each user.

Furthermore, the protocol according to the present invention permits, through the use of metadata identifying each music track, the recognition of the specific information of each structure and the simultaneous application to all financial streams of any requests for updates of the underlying structure in order to regulate the activity thereof, e.g. mechanical rights, taxes and any future regulations, thereby guaranteeing a transparent and constantly up-to-date management.

Any alternative embodiments and implementations of the protocol which have not been described in detail herein, but which will be apparent to a person skilled in the art in light of the contents of the present patent application, shall be considered to fall within the protection scope of the present invention.

### REFERENCE NUMERALS

Blockchain B
Structure node N1
Smart contract S
Metadata collector smart contract S1
Subdivision creator smart contract S2
Metadata creator smart contract S3
Subdivision smart contract S4
Type A subdivision smart contract S4A
Type B subdivision smart contract S4B
Norming user Un
Regulating user Ur
Address 3

1-12. (canceled)

13. Modular protocol for managing a plurality of streams of certified and verifiable data in blockchain systems; said protocol comprising:
a plurality of smart contracts saved on a blockchain, adapted to be executed when predetermined conditions are achieved;
said smart contracts being executed on nodes comprised in said blockchain;
said protocol defining a hierarchical structure of execution of said smart contracts, for managing and distributing to various addresses, associated with users, the plurality of streams of certified and verifiable data circulating in the blockchain;
at least one metadata collector smart contract adapted to retrieve and identify, within said plurality of streams of certified and verifiable data, data which comprise at least one metadatum of interest, which have to be normalized;
at least one subdivision smart contract adapted to receive the plurality of streams of certified and verifiable data comprising at least one metadatum of interest to be normalized and distribute the at least one metadatum of interest towards one or more addresses, associated with one or more users, and/or towards another subdivision smart contract;
said metadata collector smart contract is adapted to direct the retrieved and identified data towards a hierarchically highest subdivision smart contract within the hierarchical structure of execution of said smart contracts;
said metadata collector smart contract is controlled and managed by a norming user adapted to:
define said at least one metadatum of interest through which said at least one metadata collector smart contract retrieves and identifies said plurality of streams of certified and verifiable data;
identify and address the hierarchically highest subdivision smart contract, concerning to said hierarchical structure of execution of said smart contracts;
recognize and designate one or more regulating users capable of contributing to the management of the hierarchical structure of execution of said smart contracts;
each subdivision smart contract defines a node of the hierarchical structure of execution of said smart contracts;
each subdivision smart contract is identifiable as belonging to one of the following subcategories:
Type A subdivision smart contract, which is adapted so that only the norming user is able to propose a modification to said type A subdivision smart contract, and a verification by the norming user will always be necessary for a modification to said type A subdivision smart contract to be approved;
Type B subdivision smart contract, which is adapted so that only one regulating user of the one or more regulating users is able to propose a modification to said type B subdivision smart contract, and a verification by the only one regulating user will always be necessary for a modification to said type B subdivision smart contract to be approved.

14. The protocol according to claim 13, comprising the following additional smart contracts:
at least one subdivision creator smart contract adapted to create rules and clauses for norming the plurality of streams of certified and verifiable data circulating in the hierarchical structure of execution of said smart contracts; and/or
at least one metadata creator smart contract adapted to create rules for norming an operation of said at least one metadata collector smart contract;
said at least one subdivision smart contract being defined through said subdivision creator smart contract;
said norming user is qualified to provide information and parameters for the operation of said at least one subdivision creator smart contract and/or said at least one metadata creator smart contract.

15. The protocol according to claim 14, wherein said at least one metadatum of interest to be retrieved and identified in the plurality of data streams by the metadata collector smart contract is defined exclusively by said norming user;
said subdivision creator smart contract is adapted to create rules defined by said norming user, who shall specify:
addresses associated with one or more users and/or addresses of one or more subdivision smart contracts;
one or more streams of certified and verifiable data subdivision percentages;
said norming user is qualified to specify and/or recognize users who may modify a subdivision smart contract.

16. The protocol according to claim 14, wherein said subdivision creator smart contract is adapted to define a map of nodes of the hierarchical structure of execution of said smart contracts, which is a vector adapted to associate identification codes of the structure nodes, having a domain and subdomain structure, with the addresses of the nodes of the hierarchical structure of execution of said smart contracts.

17. The protocol according to claim 16, wherein said subdivision creator smart contract is adapted to create a new node of the hierarchical structure of execution of said smart contracts.

18. The protocol according to claim 14, wherein said at least one metadata creator smart contract is adapted to define a metadata map, which is a vector adapted to associate identification codes, related to said metadata collector smart contract, with a composite data structure, the composite data structure being identifying and univocal by a metadatum.

19. The protocol according to claim 18, wherein said metadata creator smart contract is adapted to create a new metadata collector smart contract.

20. The protocol according to claim 13, wherein said type B subdivision smart contract is adapted to create and manage substructures of the hierarchical structure of execution of said smart contracts, and is only modifiable following a proposal by the regulating user.

21. The protocol according to claim 13, wherein a hierarchical structure of execution of said smart contracts is defined in management of a stream of the plurality of streams of certified and verifiable data with multi-level and branched structures.

22. The protocol according to claim 13, comprising a modular protocol for managing a plurality of financial streams in blockchain systems, adapted to ensure distribution over multi-level and branched hierarchical structures of execution of said smart contracts, wherein said addresses, associated with the various users, are wallets towards which said financial streams have to be distributed.

23. The protocol according to claim 22, wherein said at least one metadatum of interest identifies one or more of the following pieces of information:
music track;
interpreter;
artist;
identifier of movable or immovable property;
a service;
a company.

24. A blockchain comprising:
a plurality of nodes crossed by the plurality of streams of certified and verifiable data;
the protocol according to claim 13.

25. A blockchain comprising:
a plurality of nodes crossed by the plurality of streams of certified and verifiable data comprising financial streams in one or more cryptocurrencies;
the protocol according to claim 13.
